(19) United States
(12) Patent Application Publication
(10) Pub. No.: US 2023/0405793 A1
(43) Pub. Date: Dec. 21, 2023

(54) An Oscillating Power Tool

(71) Applicant: Robert Bosch GmbH, Stuttgart (DE)

(72) Inventors: Jeremy Rubens, Palatine, IL (US); Jaime Moreno Terrazas, Imperial, CA (US); Robert Ward, Philadelphia, PA (US)

(21) Appl. No.: 18/250,482

(22) PCT Filed: Oct. 1, 2021
(86) PCT No.: PCT/EP2021/077134

§ 371 Date: Apr. 25, 2023

Related U.S. Application Data
(60) Provisional application No. 63/106,476, filed on Oct. 28, 2020.

(51) Int. Cl. B25F 5/02

(52) U.S. Cl. CPC B25F 5/02; B25F 3/00

(57) ABSTRACT

An oscillating power tool includes a housing and a motor at least partially disposed within the housing and having a rotational output shaft. An eccentric bearing is attached to the output shaft. An oscillating member is coupled to the eccentric bearing to convert rotational movement of the eccentric bearing into oscillating movement. A pivot shaft has an oscillating axis and the oscillating member is arranged on it. A tool engagement area is disposed on the oscillating member for engaging a detachable tool. The tool engagement area substantially surrounds the oscillating axis and has protruding tool connecting members extending parallel to the oscillating axis for axial mounting of the detachable tool to the tool engagement area.

### TECHNICAL FIELD

This disclosure relates to the field of power tools, and more particularly to an oscillating power tool.

### BACKGROUND

Oscillating power tools are lightweight, handheld tools configured to oscillate various accessory tools and attachments, such as cutting blades, sanding discs, grinding tools, and many others. The accessory tools and attachments can enable the oscillating power tool to shape and contour workpieces in a many different ways.

The typical oscillating power tools are comprise a motor having an output shaft and an eccentric bearing attached to the output shaft. An oscillating member or fork is coupled to the eccentric bearing to convert rotational movement of the eccentric bearing into oscillating movement. A pivot shaft has an oscillating axis and the oscillating member is arranged on it. A tool engagement area is disposed on the oscillating member for engaging a detachable tool. These components typically require precision fits since they are transferring the load from the eccentric bearing to the blade. These precision fits can add cost and complexity to the tool.

### SUMMARY

One aspect of this disclosure is directed to an oscillating power tool, comprising: a housing; a motor at least partially disposed within the housing and having a rotational output shaft; an eccentric bearing attached to the output shaft; an oscillating member coupled to the eccentric bearing to convert rotational movement of the eccentric bearing into oscillating movement; a pivot shaft which has an oscillating axis and on which the oscillating member is arranged; a tool engagement area disposed on the oscillating member for engaging a detachable tool; wherein the tool engagement area substantially surrounds the oscillating axis and has protruding tool connecting members extending parallel to the oscillating axis for axial mounting of the detachable tool to the tool engagement area. This provides a simplified oscillating mechanism and blade holder. This eliminates precision interfaces between the eccentric bearing and the blade. The oscillating member or fork is a single structure (which may comprise multiple parts) that interfaces with the eccentric bearing on one side and mounts a detachable tool on the other side. This simplifies the load path so the load is not transferred through the pivot shaft.

The pivot shaft may be arranged in a first and second bearing that are located on one side of the oscillating member. This may allow a shorter axial length of the pivot axis.

The above aspect of this disclosure and other aspects will be explained in greater detail below with reference to the attached drawings.

### BRIEF DESCRIPTION OF THE DRAWINGS

FIG. 1 is a first perspective view of an oscillating power tool with a cutting blade.

FIG. 2 is a second perspective view of the oscillating power tool.

FIG. 3 is a third perspective view of the oscillating power tool without a cutting blade.

FIG. 4 is a perspective view of an oscillating member.

### DETAILED DESCRIPTION

The illustrated embodiment is disclosed with reference to the drawings. However, it is to be understood that the disclosed embodiment is intended to be merely an example that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

The Figures show parts of an oscillating power tool 10. The oscillating power tool 10 may be handheld. It may also by battery powered. The oscillating power tool 10 has a housing 12 which may be comprised of two shell halves 14 of which only one is shown. A motor 16 is at least partially disposed within the housing 12. The motor 16 has a rotational output shaft 18. An eccentric bearing 20 is attached to one end of the shaft 18. An oscillating member 22 or fork is coupled to the eccentric bearing 20 to convert rotational movement of the eccentric bearing 20 into oscillating movement. The oscillating member 22 is arranged on a pivot shaft 24 which has an oscillating axis 26. The oscillating member 22 and the pivot shaft 24 are connected via a press fit. But they may also be connected with another method such as welding or they may have a form fit. The eccentric bearing 20, oscillating member 22, pivot shaft 24 may be arranged in a head housing (not shown).

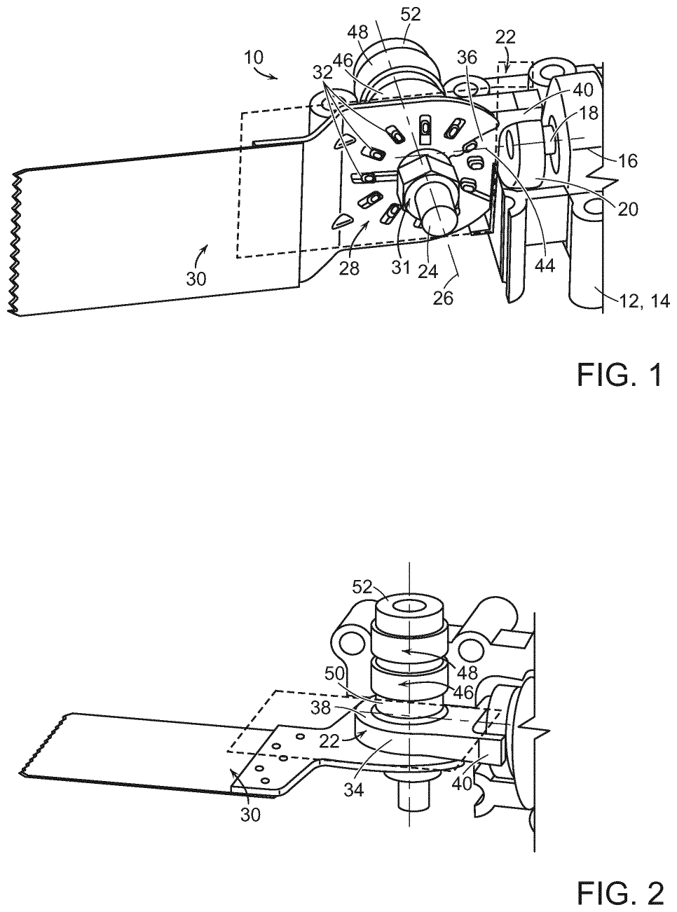

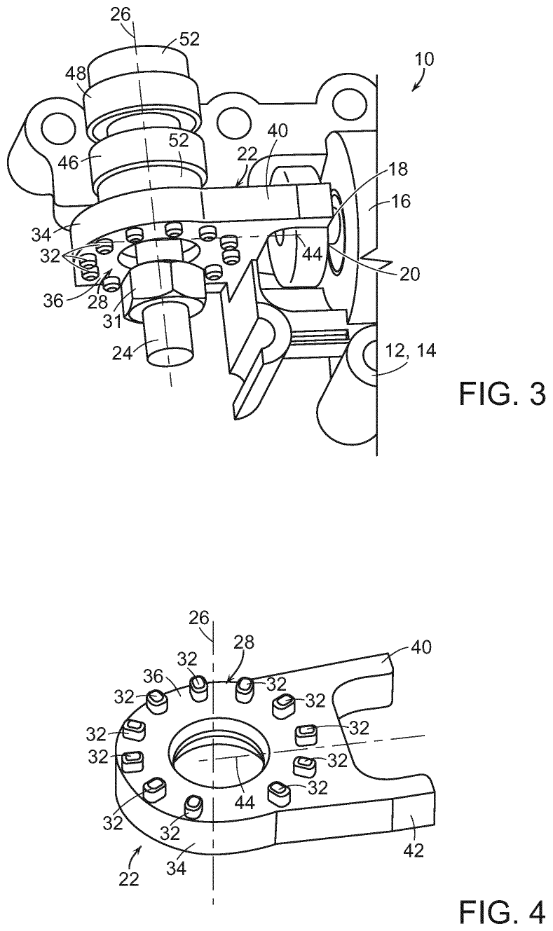

A tool engagement area 28 is disposed on the oscillating member 22 for engaging a detachable tool 30. The detachable tool 30 in FIG. 1 is a cutting blade. But other detachable tools may be attached such as sanding discs or grinding tools. The detachable tool 30 is attached with a nut 31 but may also be attached in different ways. The tool engagement area 28 substantially surrounds the oscillating axis 26 or pivot shaft 24 and has protruding tool connecting members 32. The connecting members 32 extend parallel to the oscillating axis 26 for axial mounting of the detachable tool 30 to the tool engagement area 28. There are several tool engagement members 32 having the shape of pins but other shapes may be used. The oscillating member 22 comprises a ring 34 with which it is arranged on the pivot shaft 24. The oscillating member 22 or ring 34 has a first axial surface 36 and a second axial surface 38. The tool engagement area 28 is arranged on the first axial surface 36. The tool engagement members 32 raise from the first axial surface 36.

The oscillating member 22 comprises a first arm 40 and a second arm 42 (FIG. 4). The arms 40, 42 are parallel to each other. The arms 40, 42 extend away from the ring 34 and are coupled to the eccentric bearing 20. The arms 40, 42 are parallel to each other and define a symmetry axis 44 between them which is arranged at a right angle to the oscillating axis 26. The ring 34 has an axial thickness that extends between the first and second axial surfaces 36, 38. A corresponding thickness of the of the arms 40, 42 is equal to the thickness of the ring 34. The oscillating member 22 may be a die-cast part, 3D printed, milled or made from another suitable process. It may be a single part of made of several parts.

The pivot shaft 24 is arranged in a first and second bearing 46, 48. The two bearings 46, 48 are arranged on one side of the oscillating member 22. For axial alignment the bearings 46, 48 abut distance rings 50, 52 to position them in the above mentioned head housing. Arranging the two bearings 46, 48 on one side of the oscillating member 22 may allow a shorter axial length of the pivot axis 26.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. An oscillating power tool, comprising:
a housing;
a motor at least partially disposed within the housing and having a rotational output shaft;
an eccentric bearing attached to the output shaft;
an oscillating member coupled to the eccentric bearing to convert rotational movement of the eccentric bearing into oscillating movement;
a pivot shaft which has an oscillating axis and on which the oscillating member is arranged;
a tool engagement area disposed on the oscillating member for engaging a detachable tool;
wherein the tool engagement area substantially surrounds the oscillating axis and has protruding tool connecting members extending parallel to the oscillating axis for axial mounting of the detachable tool to the tool engagement area.

2. The oscillating power tool of claim 1, wherein the oscillating member comprises a ring arranged on the pivot shaft with a first axial surface and a second axial surface wherein the tool engagement area is arranged on the first axial surface.

3. The oscillating power tool of claim 2, wherein the oscillating member comprises two parallel arms extending away from the ring and coupled to the eccentric bearing.

4. The oscillating power tool of claim 3, wherein the arms are parallel to each other and define a symmetry to an axis which is arranged at a right angle to the oscillating axis.

5. The oscillating power tool of claim 4, wherein the ring has an axial thickness that extends between the first and second axial surfaces and which is the same as a thickness of the arms.

6. The oscillating power tool of claim 1, wherein the oscillating member and the pivot shaft are connected via a press fit.

7. The oscillating power tool of claim 1, wherein the pivot shaft is arranged in two bearings and the two bearings are on one side of the oscillating member.
